(19) United States
(12) Patent Application Publication
(10) Pub. No.: US 2004/0203570 A1
(43) Pub. Date: Oct. 14, 2004

(54) Apparatus and method for utilizing an emergency button of a communication device accessory

(76) Inventor: Jeffrey Berger, Palatine, IL (US)

Correspondence Address: MOTOROLA INC, 600 NORTH US HIGHWAY 45, ROOM AS437, LIBERTYVILLE, IL, 60048-5343, US

(21) Appl. No.: 10/306,188

(22) Filed: Nov. 27, 2002

(51) Int. Cl. H04M 11/00; H04Q 7/20; H04M 1/00; H04B 1/38

(52) U.S. Cl. 455/404.1; 455/459; 455/564

(57) ABSTRACT

An apparatus and method for placing a call to an emergency response center is provided. The apparatus comprises a communication device (100) and an accessory (102, 104) located remote from the communication device. The communication device (100) is configured to establish a wireless connection with the emergency response center via a cellular interface (324) in response to receiving an emergency signal. The accessory (102, 104) has an emergency button (118, 128, 130) and configured to send the emergency signal to the communication device (100) via an air interface (218, 316) when the emergency button is activated. The communication device (100) or the accessory (102, 104) receives, via the air interface (218, 316), the emergency signal indicating that the emergency button (118, 128, 130) of the accessory (102, 104) has been activated. The communication device (100) then establishes, via the cellular interface (324), a wireless connection with the emergency response center in response to receiving the emergency signal.

### FIELD OF THE INVENTION

The present invention relates generally to the field of portable electronic devices and their accessories. More particularly, the present invention relates to the field of accessories for mobile communication devices that provide assistance in placing emergency calls.

### BACKGROUND OF THE INVENTION

Mobile communication device, such as cellular phones, are commonly used to communicate with a variety of entities. In particular, a mobile communication device may be use in an emergency situation to place a call to an emergency response center for aid and assistance. Unfortunately, most mobile communication devices are not quickly and conveniently accessible for dialing a number in an emergency situation. For example, a user carrying a mobile communication device at the user's waist or in a bag may not find the device to be easily accessible when the user is prone or trapped. Moreover, a user in a high stress situation may not have the time or wits to find his or her mobile communication device and dial the correct emergency number. Accordingly, there is a need for an accessible accessory for assisting a mobile communication device to quickly and conveniently place a call to an appropriate emergency response center.

### BRIEF DESCRIPTION OF THE DRAWINGS

FIG. 1 is a perspective view of an exemplary communication device and exemplary accessories in accordance with the present invention.

FIG. 2 is a block diagram representing various possible components of the exemplary accessories that may be used to illustrate various embodiments of the accessories as shown and described herein.

FIG. 3 is a block diagram representing various components of the exemplary communication device.

FIG. 4 is a flow diagram representing preferred operations of the exemplary accessory and/or the exemplary communication device.

### DETAILED DESCRIPTION OF THE PREFERRED EMBODIMENTS

The present invention is an apparatus for placing a call to an emergency response center. The apparatus comprises a communication device and an accessory located remote from the communication device. The communication device is configured to establish a wireless connection with the emergency response center via a first interface in response to receiving an emergency signal. The accessory has an emergency button and configured to send the emergency signal to the communication device via a second interface when the emergency button is activated. The first interface is a wireless connection, such as a cellular based connection, for communication between the communication device and the emergency response center, and the second interface may be a wired connection or an air interface, such as a personal area network (“PAN”).

The present invention is also a method for placing a call to an emergency response center from an accessory via a communication device. The communication device or the accessory receives, via a first interface, the emergency signal indicating that the emergency button of the accessory has been activated. The communication device then establishes, via a second interface, a wireless connection with the emergency response center in response to receiving the emergency signal. In contrast to the apparatus above, the first interface utilized by the method may be a wired connection or an air interface, such as a WAN, and the second interface is a wireless connection, such as a cellular-based connection, for communication between the communication device and the accessory.

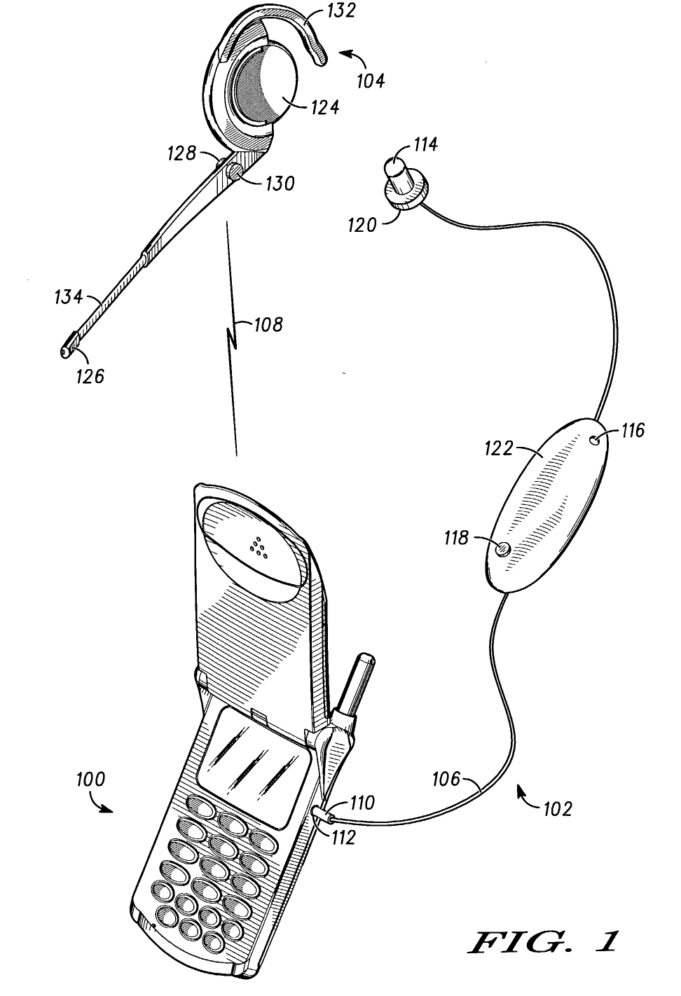

Referring to FIG. 1, there is provided a diagram illustrating an exemplary mobile communication device 100 and two exemplary accessories 102, 104 in accordance with the present invention. The mobile communication device 100 is capable of wireless communication with a wide variety of telecommunications destinations, such as an emergency response center (not shown). The accessory 102, 104 is preferably a hands-free accessory that communicates with the mobile communication device 100 via a wire connection 106 or a wireless connection 108. For the wired connection 106, the accessory includes a wired connector 110 that removably attaches to an external connector 112 of the mobile communication device 100. In the alternative, the wired connection 106 may be affixed to the mobile communication device 100 and connected to its internal electronic components.

Examples of the mobile communication device 100 include, but are not limited to, cellular telephones, paging devices, personal digital assistants, portable computing devices, and the like, having wireless communication capabilities. The mobile communication device's capability of wireless communication with a wide variety of telecommunications destinations may utilize a standard wireless telecommunication protocol including, but is not limited to, analog, CDMA, GSM, TDMA, and UMTS. The wireless connection 108 between the mobile communication device 100 and the wireless accessory 104 may utilize a standard point-to-point or ad hoc network protocol including, but is not limited to, Bluetooth, IEEE 802.11 (such as a, b and g), HomeRF, proprietary RF communications, and infrared communications.

The wired accessory 102 comprises an audio output 114, an audio input 116, and one or more emergency buttons 118 electrically coupled to each other and the wired connector 110. For example, as shown by example in FIG. 1, the audio output 114 may be a speaker supported within an earpiece 120, the audio input may be a microphone supported within a module 122, and the emergency button or buttons may be supported within the module. Also, electronic conductors may be used to couple the components of the module 122 to the wired connector 110 and the components of the earpiece 120.

Similar to the wired accessory 102, the wireless accessory 104 comprises an audio output 124, an audio input 126, and one or more emergency buttons 128, 130 electrically coupled to each other. For example, as shown by example in FIG. 1, the audio output 124 may be a speaker supported at one end of an earpiece 132, the audio input 126 may be a microphone supported by a boom 134 connected to another end of the earpiece, and the emergency button or buttons 128, 130 may be supported at an outer surface between the ends of the earpiece. Also, the earpiece may also support a wireless module (described below) for communication with the mobile communication device 100 via an air interface.

For hands-free operation, the accessory 102, 104 includes a headset support, such as earpiece 120, 132, configured to support the accessory on a user's head. In particular, the earpiece 120, 132 of the accessory 102, 104 is configured to support the audio output 114, 124 adjacent to a user's ear and a mouthpiece support, such as module 122 and boom 134, configure to support the audio input 116, 126 adjacent to a user's mouth. The audio output 114, 124 is configured to emit audio information received from the communication device 100, and the audio input 116, 126 is configured to collect audio information to be sent to the communication device.

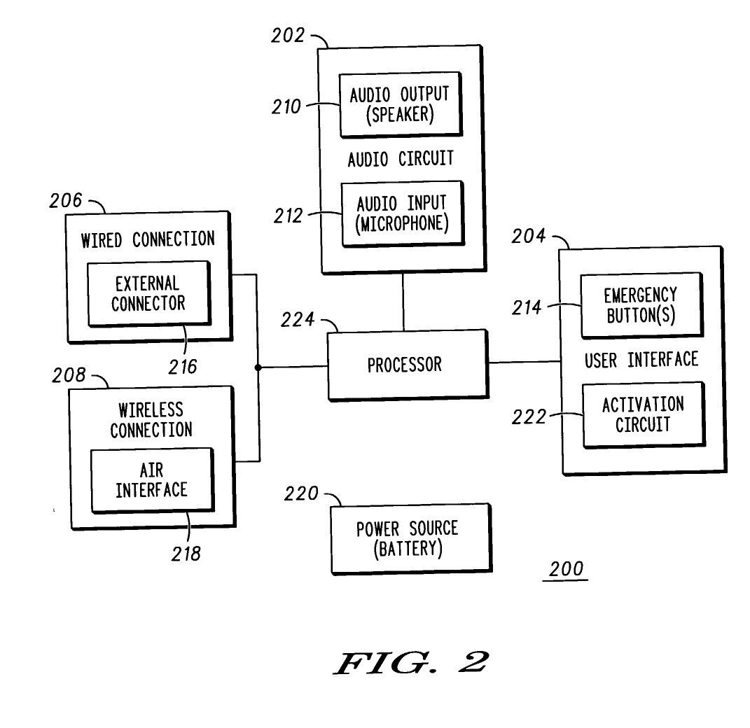

Referring to FIG. 2, an accessory 200 may come in a wide variety of different configurations. Essentially, such as for a first preferred embodiment, the accessory 200 comprises an audio circuit 202, a user interface 204 and a connection 206, 208 to the mobile communication device 100. The audio circuit 202 includes an audio output 210, such as a speaker, and an audio input 212, such as a microphone. The user interface 204 includes one or more emergency buttons 214. Preferably, each emergency button is a push-to-activate button, a break-to-activate button, or a multi-button combination. The connection to the mobile communication device 100 may be a wired connection 206, such as an external connector 216 for receiving a wired connector, or a wireless connection 208, such as an air interface 218, or both. Also, the audio circuit 202 and the user interface 204 are electrically coupled to the connection 206, 208.

Electrical power for the components of the accessory 200 may be received from a power source 220, such as battery or generator, housed with the accessory or from the mobile communication device 100 via the wired connection 206. The wireless accessory 104 would derive power from the power source 220. While the wired accessory 102 may have self-contained power via the power source 220, it is expected that power would be derived from the mobile communication device 100 through wiring in the wired connector 206.

For a second preferred embodiment, the accessory 200 may include the components of the first preferred embodiment described above and further include an activation circuit 222 operably coupled to the emergency button or buttons 214. The activation circuit 222 processes each key selection pattern or performs key de-bouncing. Preferably, the emergency button or buttons 214 are coupled to the activation circuit 222 and, in turn, the activation circuit is coupled to the connection 206, 208. Also, similar to the first preferred embodiment, the connection to the mobile communication device 100 may be a wired connection 206, a wireless connection 208, or both, and the power source 220 may be optionally included.

For a third preferred embodiment, the accessory 200 may include the components of the first preferred embodiment described above and further include a processor 224 operably coupled to the user interface 204 and, optionally, the audio circuit 202. The processor 224 is capable of controlling the general functions of the accessory, such as performing the functions of the activation circuit 222 if one is not available and performing the functions of the connection 206, 208 if a wired connection 206 or wireless connection 208 is not available. In addition, the processor may perform functions that enhance the functions of the audio circuit 202 and the user interface 204 such as improving the sound quality and/or reducing the noise communicated with the audio circuit and programming the emergency button or buttons 214 to associate with specific emergency numbers or certain audio and/or visual properties. Also, similar to the first and second preferred embodiments, the connection to the mobile communication device 100 may be a wired connection 206, a wireless connection 208, or both, and the power source 220 may be optionally included.

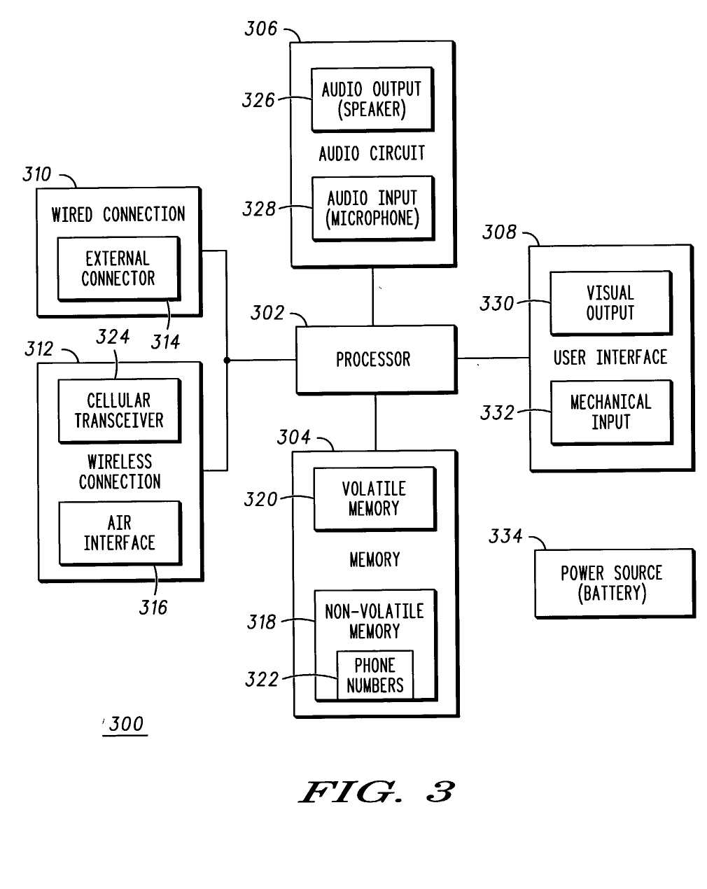

Referring to FIG. 3, there is provided a block diagram representing various components of an exemplary mobile communication device 300. The mobile communication device 300 comprises a processor 302, a memory circuit 304, an audio circuit 306, a user interface 308, and a connection 310, 312 to the accessory 200. The processor 302 is capable of performing general functions of the mobile communication device 300, such as establishing a wireless connection with an emergency response center. The processor 302 may receive a status of the emergency switch or button, particularly a switch-activated status, from the accessory 200 and/or information for dialing an emergency number associated with the emergency response center.

The processor 302 may receive the information from the connection, namely the wired connection 310, the wireless connection 312, or both. The wired connection 310 may be an external connector 314 for receiving a wired connector, and the wireless connection 312 may be an air interface 316 that utilizes a standard point-to-point or ad hoc network protocols including, but is not limited to, Bluetooth, IEEE 802.11 (such as a, b and g), HomeRF, proprietary RF communications, infrared communications, and the like.

The processor 302 may dial an emergency number associated with the emergency response center by looking-up the appropriate emergency number in the memory circuit 304 and connecting to the emergency number via the wireless connection 312. The memory circuit 304 includes non-volatile memory 318, such as flash memory, and may optionally include volatile memory 320 to enhance the performance of the processor. Although the memory circuit 304 is shown coupled to the processor 302, it is to be understood that the memory circuit 304 may be integrated within the processor 302 with minimal change in the function of the mobile communication device 100. The non-volatile memory 318 includes important information that must be retained even when the mobile communication device 100 is powered-off, such as phone numbers 322 or similar contact addresses). Preferably, the non-volatile memory 318 includes an emergency number corresponding to each emergency button of the accessory. In the alternative, the mobile communication device 100 may receive such the emergency number or numbers from the accessory 200 via the connection 310, 312. The wireless connection 312 is coupled to the processor 302 and includes a transceiver 324 that provides wireless communication with a wide variety of telecommunications destinations and utilizes a standard wireless telecommunication protocol including, but not limited to, a cellular-based communication protocol such as analog, CDMA, GSM, TDMA and UMTS.

The audio circuit 306 of the mobile communication device 300 is coupled to the processor 302 and includes an audio output 326, such as a speaker, and an audio input 328, such as a microphone. The user interface 308 of the mobile communication device 300 is also coupled to the processor 302 and may include a visual output 330, such as a display, and/or a mechanical input 332, such as a keypad.

Electrical power for the components of the mobile communication device 300 may be received from a power source 334, such as battery or generator, housed with the mobile communication device. While the mobile communication device 300 may derive power from a wired connection, such as a charging unit, the device must have the capability of utilizing self-contained power via the power source 334 in order to function as a mobile communication device in accordance with the present invention.

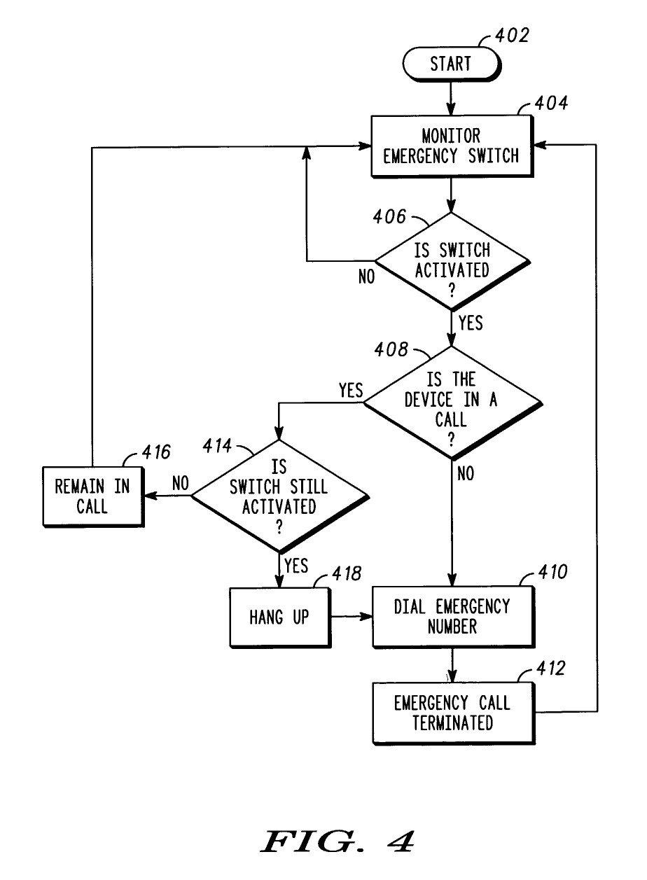

Referring to FIG. 4, in conjunction with FIGS. 2 and 3, there is provided a flow diagram 400 representing two preferred operations of the exemplary accessory and/or the exemplary communication device. For a first preferred operation, the functions represented by the flow diagram 400 are performed primarily by the processor 302 of the mobile communication device 300. For a second preferred operation, certain functions represented by the flow diagram 400 are performed by the processor 302 of the mobile communication device 300 whereas other functions are performed by the processor 224 and/or activation circuit 222 of the accessory 200.

For the first preferred operation, starting at step 402, one or more emergency switches or buttons 214 of the accessory 200 are monitored by the processor 302 of the mobile communication device 300 based on signals received directly or indirectly from the accessory at step 404. In monitoring the emergency button or buttons 214, the processor 302 attempts to detect whether an emergency button has been activated by a user at step 406. After the processor 302 detects that an emergency button 214 has been activated, the processor 302 determines whether the mobile communication device 300 is in a call at step 408. If the mobile communication device 300 is not in a call, then the processor 302 dials an emergency number associated with the emergency response center or otherwise contacts the center via the transceiver 323 at step 410. Thereafter, after the call is terminated by the mobile communication device 300 or the emergency response center at step 412, and the processor 302 returns to monitoring the emergency button or buttons 214 of the accessory 200 at step 404.

If the mobile communication device 300 has a call in-progress at step 408, then the processor 302 determines whether the emergency button 214 is still activated at step 414. If the emergency button 214 is becomes inactive, then the processor 302 remains in the existing call at step 416 and returns to monitoring the emergency button or buttons at step 404.

In an emergency situation, a user would either hold the emergency button 214 or press the button repeatedly. If the person that the user is communicating with does not appear to be able to assist the user, then the user may continue to activate the emergency button 214 in attempt to contact the emergency response center. Thus, if the emergency button 214 is still activated at step 414, then the processor 302 terminates the existing call at step 418 and dials an emergency number associated with the emergency response center or otherwise contacts the center via the transceiver 323 at step 410. Thereafter, after the call is terminated by the mobile communication device 300 or the emergency response center at step 412, the processor returns to monitoring the emergency button or buttons 214 of the accessory 200 at step 404.

For the second preferred operation, starting at step 402, one or more emergency switches or buttons 214 of the accessory 200 are monitored by the activation circuit 222 or the processor 224 of the accessory based on signals received from the emergency button or buttons 214 at step 404. In monitoring the emergency button or buttons 214, the activation circuit 222 or the processor 224 attempts to detect whether an emergency button has been activated by a user at step 406. After the activation circuit 222 or the processor 224 detects that an emergency button 214 has been activated, the activation circuit or the processor provides an emergency or activation signal to the processor 302 via the connection 216, 314 or the connection 218, 316. In response to receiving the signal, the processor 302 of the mobile communication device 300 determines whether the device is in a call at step 408. If the mobile communication device 300 is not in a call, then the processor 302 dials an emergency number associated with the emergency response center or otherwise contacts the center via the transceiver 323 at step 410. Thereafter, after the call is terminated by the mobile communication device 300 or the emergency response center at step 412, and the activation circuit 222 or the processor 224 of the accessory 200 returns to monitoring the emergency button or buttons 214 at step 404.

If the mobile communication device 300 has a call in-progress at step 408, then the activation circuit 222 or the processor 224 of the accessory 200 determines whether the emergency button 214 is still activated at step 414. If the emergency button 214 is becomes inactive, then the processor 302 of the mobile communication device 300 remains in the existing call at step 416, and the activation circuit 222 or the processor 224 of the accessory 200 returns to monitoring the emergency button or buttons at step 404.

If the emergency button 214 is still activated at step 414, then the processor 302 of the mobile communication device 300 terminates the existing call at step 418 and dials an emergency number associated with the emergency response center or otherwise contacts the center via the transceiver 323 at step 410. Thereafter, after the call is terminated by the mobile communication device 300 or the emergency response center at step 412, the activation circuit 222 or the processor 224 of the accessory 200 returns to monitoring the emergency button or buttons 214 at step 404.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. An apparatus for placing a call to an emergency response center comprising:
a communication device configured to establish a wireless connection with the emergency response center via a first interface in response to receiving an emergency signal; and
an accessory located remote from the communication device, the accessory having an emergency button and configured to send the emergency signal to the communication device via a second interface when the emergency button is activated.

2. The apparatus of claim 1, wherein:
the first interface includes a transceiver circuit configured to communicate wirelessly with the emergency response center; and
the communication device includes a memory circuit configured to store a phone number associated with the emergency response center, and a processor configured to instruct the transceiver to contact the emergency response center at the phone number in response to receiving the emergency signal from the accessory.

3. The apparatus of claim 1, wherein the second interface includes a wired connection coupled to the communication device and the accessory, the wired connection being configured to transfer the emergency signal from the accessory to the communication device.

4. The apparatus of claim 1, wherein the second interface includes air interfaces at the communication device and the accessory, the air interfaces being configured to transfer the emergency signal from the accessory to the communication device.

5. The apparatus of claim 1, wherein:
the communication device has an emergency mode initiated by the emergency signal and a non-emergency mode at all other times; and
the accessory is capable of providing voice information to the communication device during the emergency mode and the non-emergency mode.

6. The apparatus of claim 1, wherein the emergency button is one of a push-to-activate button, a break-to-activate button, and a multi-button combination.

7. The apparatus of claim 1, wherein the accessory includes an audio input configured to send audio signals to the communication device and an audio output configured to receive audio signals from the communication device.

8. The apparatus of claim 1, wherein the accessory includes a headset support configured to support the accessory on a user's head.

9. The apparatus of claim 1, wherein the accessory includes an earpiece support configured to support an audio output adjacent to a user's ear and a mouthpiece support configure to support an audio input adjacent to a user's mouth, the audio output configured to emit audio information received from the communication device and the audio input configured to collect audio information to be sent to the communication device.

10. The apparatus of claim 1, wherein the communication device is a cellular phone and the accessory is a headset.

11. A method for placing a call to an emergency response center from an accessory via a communication device, the method comprising the steps of:
receiving, via a first interface, an activation signal indicating that an emergency switch of the accessory has been activated; and
establishing, via a second interface, a wireless connection with the emergency response center in response to receiving the activation signal.

12. The method of claim 11, further comprising receiving information for dialing an emergency number associated with the emergency response center.

13. The method of claim 11, further comprising determining whether the communication device is in a call.

14. The method of claim 13, further comprising detecting whether the emergency switch is still activated.

15. The method of claim 14, wherein the establishing step includes terminating the call and dialing an emergency number associated with the emergency response center if the emergency switch is still activated.

16. The method of claim 14, wherein the establishing step includes remaining in the call if the emergency switch becomes inactive.
